(19) United States
(12) Patent Application Publication
(10) Pub. No.: US 2005/0054408 A1
(43) Pub. Date: Mar. 10, 2005

(54) Smart casino live card playing system and method

(76) Inventors: Rolland Nicholas Steil, Las Vegas, NV (US); John Douglas Lord, Las Vegas, NV (US)

Correspondence Address: DORR CARSON SLOAN & BIRNEY, PC, 3010 EAST 6TH AVENUE, DENVER, CO, 80206, US

(21) Appl. No.: 10/657,294

(22) Filed: Sep. 8, 2003

(51) Int. Cl. G06F 17/00; G06F 19/00

(52) U.S. Cl. 463/11

(57) ABSTRACT

A system and method for monitoring playing cards in a live casino game by reading card attributes stored in each playing card at a player position with a radio frequency reading system. Each card has a radio frequency identification tag containing at least value and suit attributes. The tracking of the dealt cards to each player position occurs in sequence and based upon wagers placed monitors play of the live card game according to rules of the live card game.

### BACKGROUND OF THE INVENTION

1. Field of the Art

The present invention pertains to live casino card games and, more particularly, to automated gaming table monitoring systems capable of tracking game play of individual play hands.

2. Background

A need exists in the casino industry for monitoring live card game play.

One product developed by Mikohn Gaming Corporation under the trademark “SAFE JACK” uses radio frequency identification (RFID) tag technology placed inside player chips on a gaming table as set forth in U.S. Pat. Nos. 5,941,769 and 6,093,103.

In U.S. Pat. No. 6,186,895, entitled “Intelligent casino chip system and method or use thereof,” an intelligent casino chip system is set forth. At least one gaming table is provided with at least one discrete player area. Each player area has a discrete betting area. Two classes of intermingled gaming chips are accepted in a stack in the discrete betting area. The gaming chip of the first class, comprising the primary wager, has a first transponder containing at least value information. The gaming chip of the second class, comprising the secondary wager, has a second transponder containing value and class information. A transceiver system located on the gaming table within the vicinity of the betting area is used to receive value signals from the first transponder and transponder value and class signals from the second transponder. These signals are conveyed to a computer system that then determines a primary wager value of the primary wager based on the value signals from the first transponder. The computer system also determines the secondary wager value as distinct from the primary wager value based on the value and class signals from the second transponder. Thus, the computer is provided with the respective wager values and the distinct class of the secondary wager when the primary wager and the secondary wager are intermingled within the discrete betting area.

In U.S. Pat. No. 6,464,584, entitled “Intelligent casino chip system and method for use thereof,” another intelligent casino chip system is disclosed. At least one gaming table is provided with at least one discrete player area. Two classes of intermingled gaming chips are accepted in the discrete betting area. Each gaming chip of the first class has a first transponder containing at least value information. Each gaming chip of the second class has a second transponder containing value and class information. The computer system determines the values from each class of chip and the class information from the second transponder.

In U.S. Pat. No. 5,707,287, entitled “Jackpot system for live card games based upon game play wagering and method therefore,” a game table system, adapted for multiple sites under a central control, for providing a progressive jackpot in a live card game is disclosed. Each gaming table has an ante bet region, a dealer card region, and a player card region. The game table system of the present invention includes a sensor located at each bet region for detecting the value of the ante placed by the player at that location, a reader identifying each card dealt during the play of the game to the player and to the dealer, a computer connected to the sensor and the reader and the progressive jackpot for adding a predetermined percentage of the value of the ante to the progressive jackpot when a predetermined game event (such as the dealer going bust during the game of blackjack) occurs while preserving the value of the ante during the conventional play of the game. The computer, under the teachings of the present invention, awards the progressive jackpot to the player with a winning sequence of cards during the play of the game. The play, however, continues with the other players.

German Patent Application No. P44 39 502.7 sets forth a computerized device that reads cards as they are dealt from a shoe and also senses when a hand is receiving cards at a position on a game table. The computer tracks each hand and records the value and suit of each card in each player's hand. The computer senses when a dealer has a blackjack and immediately issues a signal. This approach electronically surveys each game and minimizes manual inspection of the game. These computers can be linked by various means to a central computer so that numerous hands played at numerous remote locations can be exactly monitored.

A need exists to improve upon live card game monitoring by reading card and wager attributes at player positions and to verify that live card game plays occurs according to the game rules for the card game.

### SUMMARY OF THE INVENTION

A system and method for tracking playing cards in a live casino game by reading card attributes stored in each playing card at a player position with a radio frequency reading system. Each card has a radio frequency identification tag containing at least value and suit attributes. The tracking of the dealt cards to each player position occurs in sequence and based upon wagers placed monitors play of the live card game according to rules of the live card game.

### BRIEF DESCRIPTION OF THE DRAWINGS

FIG. 1 sets forth the radio frequency (RF) system components of the smart live card system of the present invention.

FIG. 2 sets forth a playing card imbedded with an RFID tag.

FIG. 3 sets forth a side view of the playing card of FIG. 2.

FIG. 4 illustrates a live card gaming table incorporating the radio frequency system of the present invention.

FIG. 5 illustrates an embodiment of the blackjack live card casino game implemented by the radio frequency system of FIG. 1.

FIG. 6 sets forth the method of the present invention for the play positions.

FIG. 7 sets forth the method of the present invention for determining doubles and splits in blackjack.

FIG. 8 sets forth the method of the present invention for maintaining the occurrences of bonus card sequences during live card play.

FIG. 9 illustrates an embodiment of a bonus blackjack sequence for the method of FIG. 8.

FIG. 10 illustrates an embodiment of a blackjack split for the method of FIG. 7.

### DETAILED DESCRIPTION OF THE INVENTION

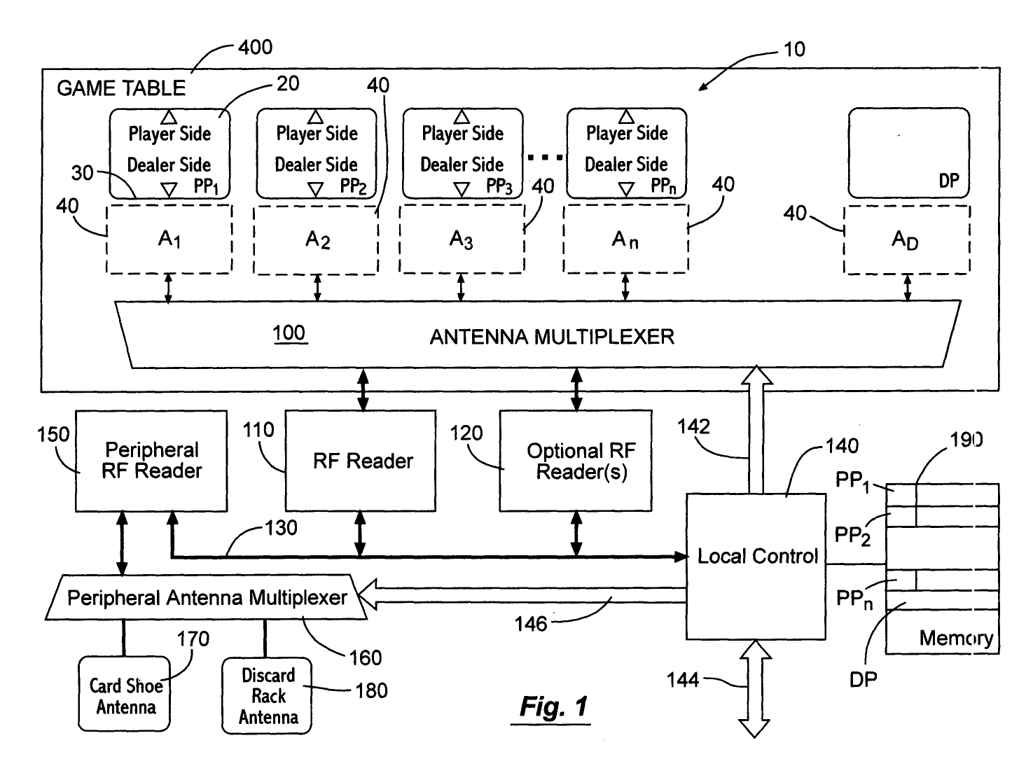

As shown in FIGS. 1-4, the radio frequency (RF) system 10 of the present invention uses a radio frequency identification (RFID) tag 210 inside each playing card 200 along with an antenna matrix 40 on the game table 400. The radio frequency system 10 can then track where each playing card 200 is on the game table and ascertain all of that card's attributes such as, but not limited to, value and suit. A “hand” is commonly defined as one deal of cards to the players in a live card game. A “deck” for a particular live card game has a predetermined number of cards. For example, blackjack may use several conventional card decks with each card deck having four “suits” (diamonds, hearts, clubs, and spades) containing 13 cards of different “value” (ace through king) for a predetermined number of 52 cards.

FIG. 1 sets forth a block diagram of the radio frequency system 10 of the present invention. FIG. 1 shows “n” player positions (PP) on the game table 400. Each player position PP has two sides termed “player side” 20 and a “dealer side” 30. The dealer position (DP) is also shown. The term “play position” as used herein means a player position PP, the dealer position DP, or any other area on the game table where playing cards are placed during play of the casino card game.

Associated with each play position is an antenna A located on the game table 400 in an antenna field area 40 (i.e., referred to in FIG. 1 as A₁-Aₙ for each player position PP and A_{D} for the dealer position DP). Interconnecting all antennae A is an antenna multiplexer 100 which is interconnected to an RF reader 110 (and to optional RF reader(s) 120). The RF reader 110 contains a radio frequency transmitter receiver, a control unit and interface to host system, not shown. The RF reader 110 (and optional RF reader(s) 120) are connected to a communication bus 130 which is in communication with a local control 140. The local control 140 is connected to antenna multiplexer 100 over antenna select lines 142 and to a system communications bus 144. The optional RF reader(s) 120 are used to increase overall speed of a complete table scan.

Also shown in FIG. 1, is an optional peripheral RF reader 150 connected to the communications bus 130 and also to a peripheral antenna multiplexer 160. The peripheral antenna multiplexer 160 is also connected to peripheral antenna select lines 146. The peripheral antenna multiplexer 160 is connected to at least two additional antennas, in one embodiment. The first is a card shoe antenna 170 and the second is to a discard rack antenna 180. These are optional features of the present invention.

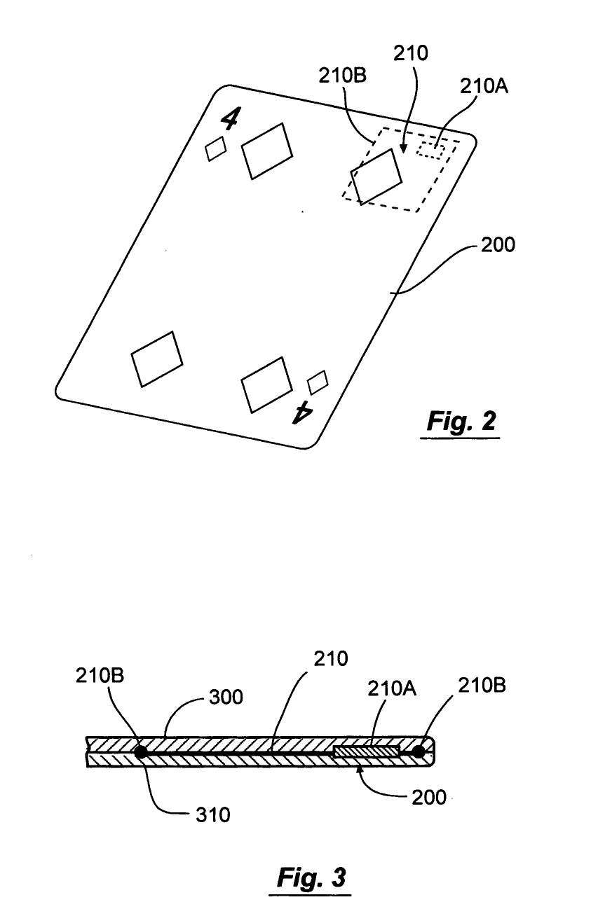

As shown in FIGS. 2 and 3 each playing card 200 has an antenna 230 connected to the RFID tag 210 inserted inside the card 200. Each tag 210 contains “attributes” stored in memory in the tag.

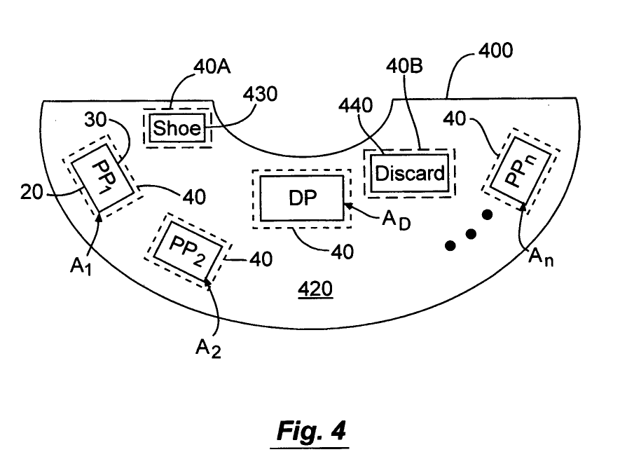

As shown in FIGS. 1 and 4, on the gaming table 400, there is an antenna matrix composed of individual areas 40 that is located on the table surface 420 and controlled by the antenna multiplexer 100. The term “located on” as used herein means “on the table 400, in the table 400, and/or near the table 400”. The antenna multiplexer 100 selectively connects under commands issued from the local control 140 over antenna select lines 142 to any selected antenna A within the matrix to the RF reader 110. The RF reader 110, when connected to an antenna A at selected times during play of the casino card game, energizes the antenna A at the desired play position (e.g., PP or DP) to activate any RFID tag that is within the individual field 40 powered by that antenna. The RFID tag in a playing card(s) (or, optionally, any wager) then transmits its attributes via the connected antenna 230 to the antenna which is connected to the RF reader. The received attribute data is delivered over the communications bus 130 to the logic control 140 for storage in memory 190.

The system 10 set forth in FIG. 1 scans each antenna A by controlling select lines 142 to determine each card's value at each play position. Consequently, it is known to which player the card was dealt and consequently each player's hand (as well as the dealer's hand) in the progress of the game.

The RFID tag 210, the antenna A, the antenna multiplexer 100 and the local control 140 as well as the accompanying RF reader 110 are conventionally available.

Each playing card 200, as shown in FIGS. 2 and 3, have the RFID tag 210 inserted within the card. The tag 210 shown in FIGS. 2 and 3 also includes the electronic components 210A and antenna 210B. In this fashion, the tag 210 is not seen by a player. As shown in FIG. 3, one approach would be to have the card 200 have two laminates 300 and 310 with the tag 210 laminated therebetween. The tag 210 is of conventional size and is small enough and thin enough to be firmly held between the two laminates 300 and 310. How the tag 210 is affixed to the playing card 200 does not limit the claimed invention. The tag 210 can be located anywhere within the card 200 and is not limited to the upper right hand corner as shown in FIG. 2. While the tag 210 is shown to be within the card 200 as shown in FIG. 3, it could also be on the upper or lower surface or the outer surface of the card. Where the tag 210 is located and how it is affixed to the card is a matter of design choice within the teachings of the present invention.

In each tag 210 for each playing card 200, the tag has memory containing the attributes of the card. The “attributes” include the value and suit, but can also include, depending on design requirements, any other suitable attribute, such as, but not limited to, an: identification number, casino data, date information, deck identity, etc. It may even include a bonus data field for separate play of a bonus game. For example, in a 52 card deck without jokers, the card identity corresponding to the value and suit of the card is stored. If jokers are present, the identity of the joker is stored in the tag's memory. Whatever the composition of the deck of cards, each card has its own unique identity and that unique identity is stored as an attribute in the memory of the tag for the card. For example, if a card from another deck is improperly inserted into the card game, it will be instantly discovered as being a card of proper rank and value but improper deck identity.

In FIG. 4, the optional card shoe 430 is shown on the game table 400 as well as the discard rack 440. Associated with the shoe 430 is a field area 40A for the card shoe antenna 170 and the field area 40B for the discard rack antenna 180.

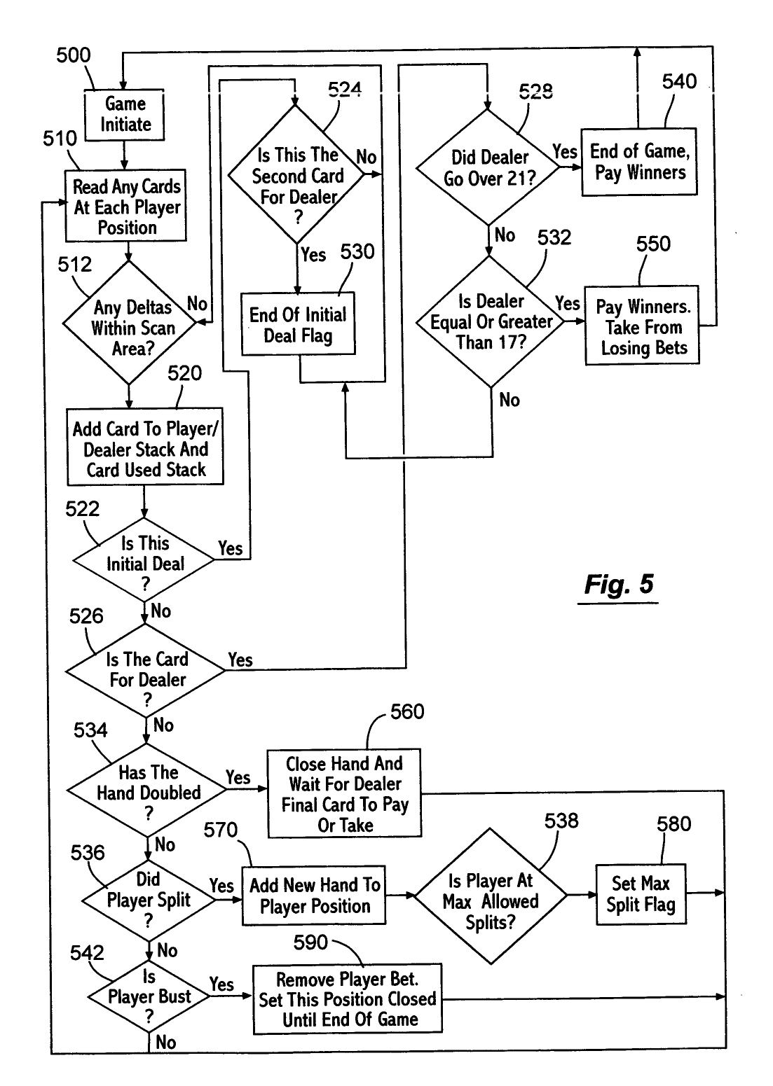

In FIG. 5, the operation of the present invention is illustrated for one embodiment of the casino game of blackjack. Other embodiments for blackjack rules exist. In FIG. 5, the game initiates in step 500. Initiation can occur in many ways such as with the placing of bets by players, the pushing of a special start game button, the sensing of the first card dealt, etc. For example, sensing the start of a game can be a combination of detecting new bets in any of the player fields by scanning the RFID player chips along with the detection of player cards entering into any of the activated player positions.

The local control 140 in step 510 scans for cards 200 physically at each play position PP and DP. For example and with reference to FIGS. 1 and 4, the local control 140 scans play position PP1 and determines the attributes (if a card is present) from any cards physically at play position PP1 then the local control scans a next position PPn (or DP) and determines the attributes, if any for cards at each position. For each position scan period (scan period=the period in which the RFID reader is connected to that position antenna), the RFID reader will detect all RFIDs within the field of view of the antenna A and thus store the appropriate attributes for each tag read. This process includes detecting not only RFIDs in cards, but wagers and any other object with embedded RFID. The table scan period (table scan period=the time to scan all positions, which is controlled and scheduled via the local controller 140 by turning on each antenna A in sequence through the antenna multiplexer 100) can be relatively short in time, an example would be that the total scan period could be less than one second in time and thus by continuously scanning will look for any changes within each player position rapidly. It is immaterial as to the order of positions that the scanning occurs. This process of reading cards (wagers, objects, etc.) in each of the play positions occurs many times during play of the casino card game. If the local control 140 detects a new card during the scan of a play position in stage 512 then, in stage 520, that new card is added to the player memory field (or the dealer memory field) in memory 190 for the player (or for the dealer). Because the scan of each player position PP and the dealer position DP occurs rapidly at the selected times, the memory contains all cards delivered to a player position and to the dealer position during play of the casino game.

The reading of each play position occurs at selected times during play of the casino game. The term “selected times” includes periodic or at selected times other than periodic.

Software in local control 140 for game table 400 is designed for rules of the live card game being played at the game table 420. This software incorporates the rules of the casino live card game. In FIG. 5, the casino live card game is blackjack. Use of blackjack as an example is not meant to limit the teachings of the present invention. The flow chart is designed for one embodiment of casino blackjack. Hence, in stage 522 a determination by the software is made as to whether this is the initial deal. If it is the initial deal, then stage 524 is entered to determine if this is the second card for the dealer. If it is not the second card for the dealer than stage 512 is re-entered and scanning of all play positions continues until, in stage 524, the dealer has a second card and then stage 530 sets an end of initial deal flag. Stage 512 is once again entered. In the initial deal storage 522, all active players are checked for blackjack which are then paid by the dealer and then the player will remove winnings from the player position. This process is stored and verified by the system of the present invention.

When the dealer has received a second card as witnessed by the setting 530 of the initial deal flag, and in stage 522 the answer is no, then stage 526 is entered. At this point in the live card game of blackjack if this is another card for the dealer then stage 528 is entered to ascertain whether the dealer has drawn over 21. If the dealer has gone over 21 then stage 540 is entered, the live card game ends and all players actively playing at player positions win. The game is over and the system waits for the next game initiate in stage 500.

However, if the dealer did not go over 21 in stage 528, then stage 532 is entered. Here a determination is made whether the dealer is equal to or greater than the value of 17 in its two cards. If the answer is yes, then according to the blackjack rules in stage 550 the dealer pays those active players having a winning hand over the dealer's hand and receives all losing bets from players who have not won. Again, the game ends.

Of course, if the dealer did not go over 21 and if the dealer does not have a hand value equal to or greater than 17 in stage 532, then play continues in stage 512. At this stage in game play, the next card is the dealers which is sensed in 512, added in 520, and determined to be for the dealer in 526. For example, assume the dealer in the initial deal received a “four” and an “eight” for a value of “twelve.” The initial deal flag is set, so the next dealer card is examined through stages 526, 528, and 532. In this example assume the next dealer card is “three,” to arrive at a value of “fifteen.” The dealer must take another card. Assume the fourth card is a “King.” This card causes the dealer to go over 21 in step 528.

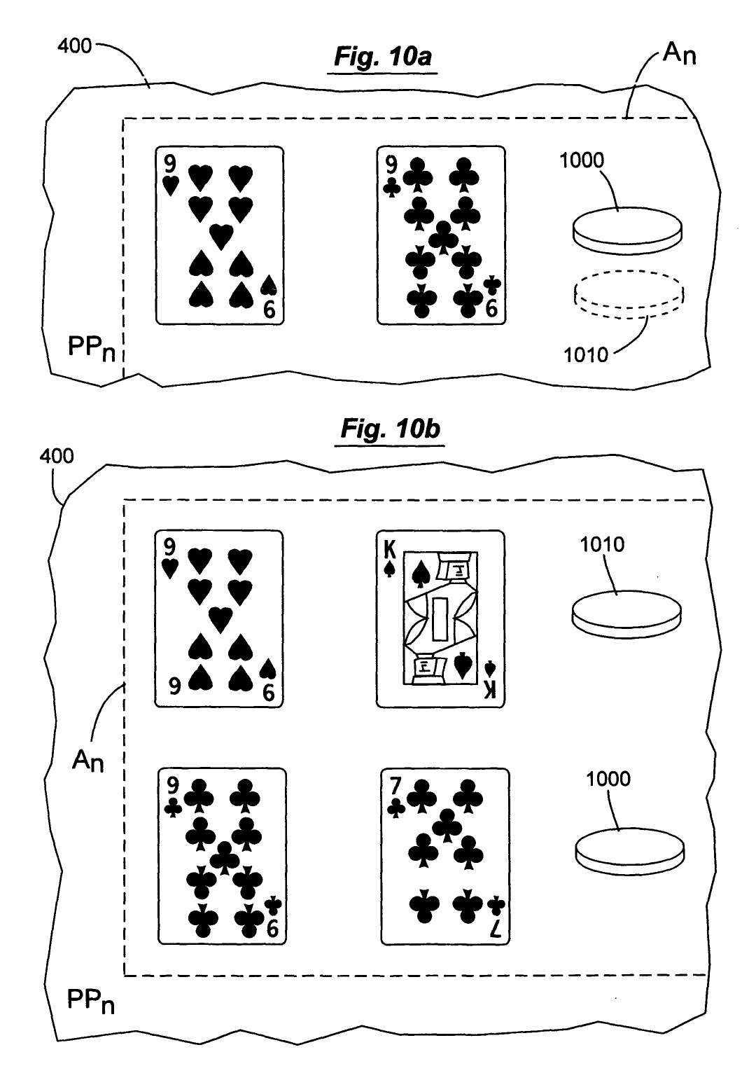

If the card is not for the dealer in 526, then the player's cards are examined. Here, the software in the logic control 140 determines whether a player's hand at a player's position PP has doubled the bet. If so stage 560 is entered in which the hand is now closed for that player position and the logic control 140 will wait for the dealer to take the final card and to either pay or take the losing bet for the doubled hand. If no doubling has occurred, then in stage 536, the local control 140 determines whether a player's hand has been split and if it has, then stage 570 is entered in which the software in the local control 140 for the casino live card game adds a new hand to that player position PP. In the case of the rules of blackjack, the player must have two identical cards and must place an addition bet in order to split hands. These cases are known by detecting new chips in the player wager area and the local controller 140 knows what the initial deal is. In FIG. 10, an example of a player receiving two “nines” is shown. The presence and value of the chip 1000 in the player wager area is detected by the controller 140 using the teachings found in U.S. Pat. Nos. 6,464,584 and 6,186,895 which are incorporated by reference herein. The player physically splits the cards, places a new wager 1010, and two new cards are delivered by the dealer which as shown in FIG. 10 are a king and a seven. The controller 140 reads the king of spades and seven of clubs as shown in FIG. 10 according to the teachings of the present invention and the placing of the required new wager 1010. Play would continue in conventional fashion. If the player goes bust on one or both hands, the dealer removes the cards and wagers 1000 and 1010 for the busted hand. This is verified by the controller both as to the removal of the cards and the wager from the play position. If the controller detects an error, an alarm or alarm message is delivered to an appropriate casino person, to an indicator, etc.

A further determination is made in stage 538 as to whether the player is at the maximum allowed number of splits and, if so, then at stage 580 a maximum split flag is set. If there is no split, then stage 542 is entered. Here a determination is made whether the player's hand is over the value of 21 and if it is the player's bet is removed and this player position is closed until the end of the game in stage 590.

In the case that the player has two nines as shown in FIG. 10, the additional bet could also be a double down 534, which would be the case if the local controller 140 sensed only one card placed within that play position and it has detected either the addition of cards for the next positions or the end of game has been detected. Otherwise, if more cards are added to that play position then the local controller would add the hands for game tracking accordingly.

FIG. 5 illustrates one blackjack embodiment of the present invention incorporating the RFID tag 210 in each player card 200. It is to be expressly understood that the method of FIG. 5 is but one embodiment and that any casino live card game can be tracked, card by card, wager by wager, wager position by wager position, player position by player position (and dealer position) for each card delivered and taken away during play of the game based upon the rules of that particular casino live card game.

The RF system 10 of the present invention tracks the play of the casino card game, stores each play position's hand, and verifies adherence to the rules of the live card game. As such it provides the casino with a full check on the dealer's play and each player's play during the play of the card game. Furthermore, the method and system of the present invention can be used to track the wagers made via suitable tags in the chips as discussed in the background section. Any deviations from game play, card insertions, wager substitutions, etc., are immediately detected with an alarm issued.

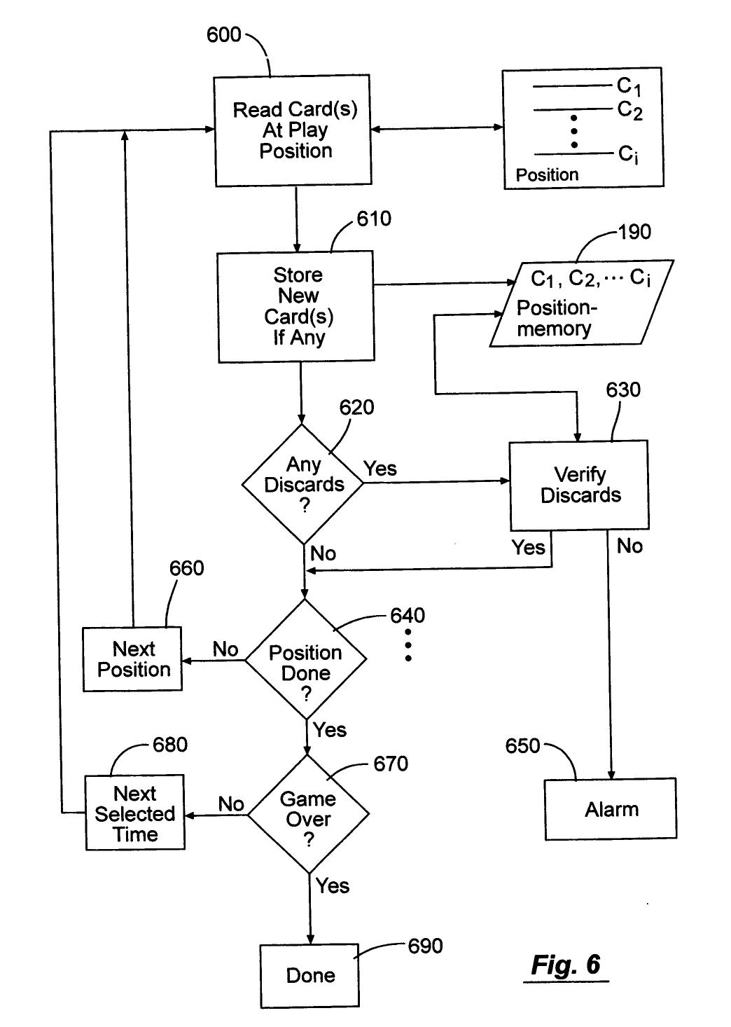

In FIG. 6, a method of the present invention is additionally set forth. In stage 600 any cards at a play position PP or DP are read. The play position is a player position, the dealer position, or, any other area receiving cards such as, for example, the discard rack position 180. In stage 600, the antenna A transmits power to the tag 210 in each card C at the play position. In stage 610, the local control 140 stores the attributes data of any new cards read at the play position into memory 190 at a memory location corresponding to the position. In stage 620, if any discards are read at the discard rack 440, the local control 140 does a comparison, in software, of the cards read at the player position 180 and compares it to the discard card attributes stored in memory 190. If the memory has a card for the position that was not read at a player position, the discard detected in stage 620 is verified in stage 630. In stage 630, the card attributes corresponding to the discarded card are marked as a discard and the local control 140 accesses memory 190 for the cards in the discard rack. The discarded card should be in the discard rack and if verification occurs stage 640 is entered. If there is no verification an alarm is sounded in stage 650. To illustrate by way of example, assume a play position has a “six of hearts” read at step 600 and stored 610 in memory 190. Later in the game, the “six of hearts” is discarded and put into the discard rack 440. The next scan of the player position shows the “six of hearts” missing and marks it as discarded in memory 190. The scan of the discard rack 440 shows the presence of the “six of hearts” and in step 630 adds the “six of hearts” to the discard memory location and verifies that it was marked discarded in the memory for the player position. The present invention is not limited to the above “marking” and “verification” process as other processes can be utilized.

In stage 640, the next position 660 is entered and the process repeats. However when the play positions are done in stage 640, then stage 670 is entered and the determination by the local control 140 is made as to whether the live casino game is over. If not, the next selected time in stage 680 occurs and the process repeats. If the game is over, the process ends 690.

It is to be understood that sensing discards is an option of the present invention and, if it is not included, then stages 620, 630 and 650 are not used. In that event, stage 610 accesses directly stage 640.

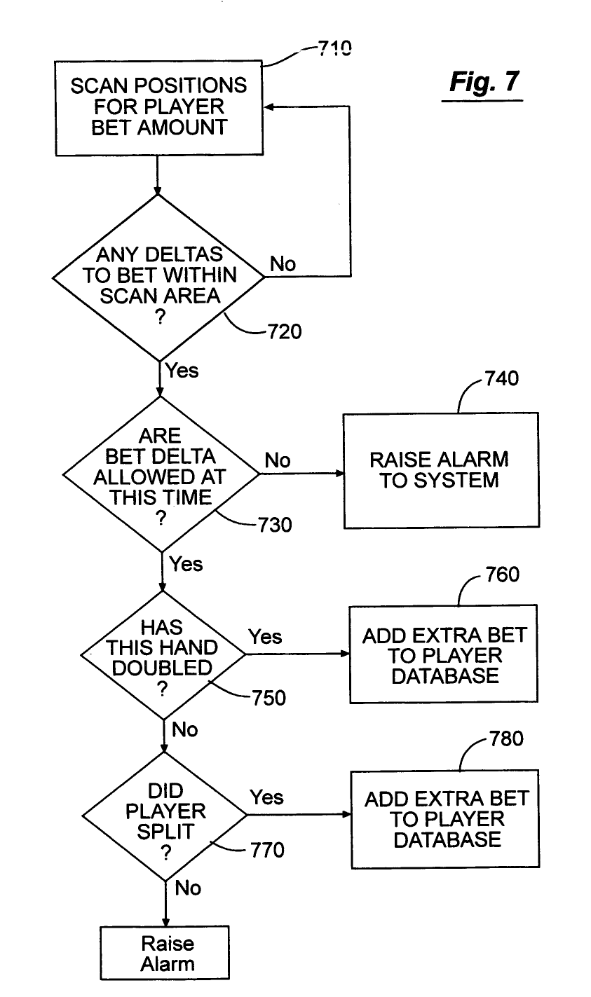

In FIG. 7, the details of a portion of the method of the present invention, in another embodiment, further illustrates a double and a split for the casino game of “blackjack” based on bets made. In FIG. 7, each player bet position is scanned in step 710 for the player bet amount. In step 720, a determination is made whether or not a change (i.e., deltas) to a bet within a player position has occurred. If not, stage 710 is returned to and, if so, stage 730 is entered. In stage 730, a determination is made whether or not the change in the bet is permitted. If not, an alarm is raised in stage 740 for possible bet tampering or mistake. For example, in the split of two “nines” shown in FIG. 10, wager 1010 and wager 1000 must equal. Or, if the cards cannot split and wager 1010 is detected, then the alarm issues. If the change is permitted, a determination is made in stage 750 as to whether or not the hand has doubled and if this has occurred, stage 750 is entered to add 760 the extra bet made by the player to the data base for the game. If not, then stage 770 has been entered to determine whether or not the player split the hand (as previously discussed) and if so, the bet is made to the player data base in stage 780. If not, an alarm is raised as a delta bet has been detected with no further cards to the play position. The cards dealt to the play position determine whether a double 750 or a split 770 is detected. With reference to FIG. 10, when the delta bet 1010 is placed (as shown by the dotted lines) and detected in stage 720, the player already has two cards in FIG. 10a. In response to a split each, the player receives at least two additional cards. In response to a double, the player receives only one card. Thus, the system knew what occurred. This is just another feature showing the breadth of the present invention. It is to be understood that separate antennae A could be used for the card area and the bet area as discussed above. Or, the same antennae A (as shown in FIG. 10) could be used to scan both card and chip RFIDs.

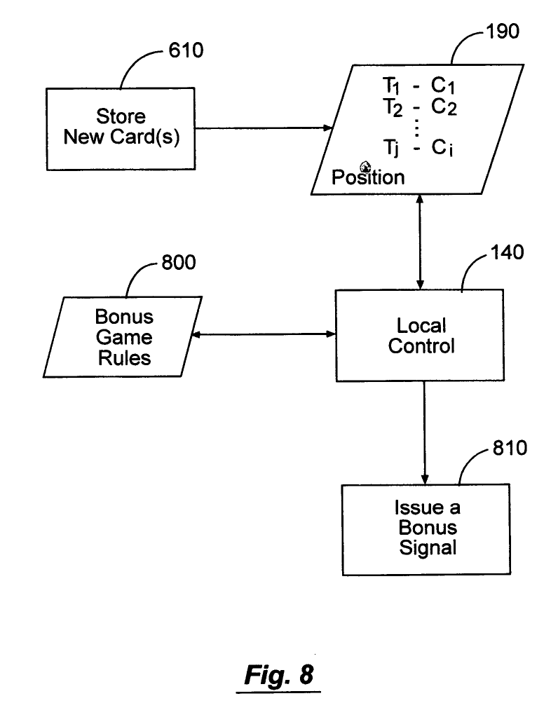

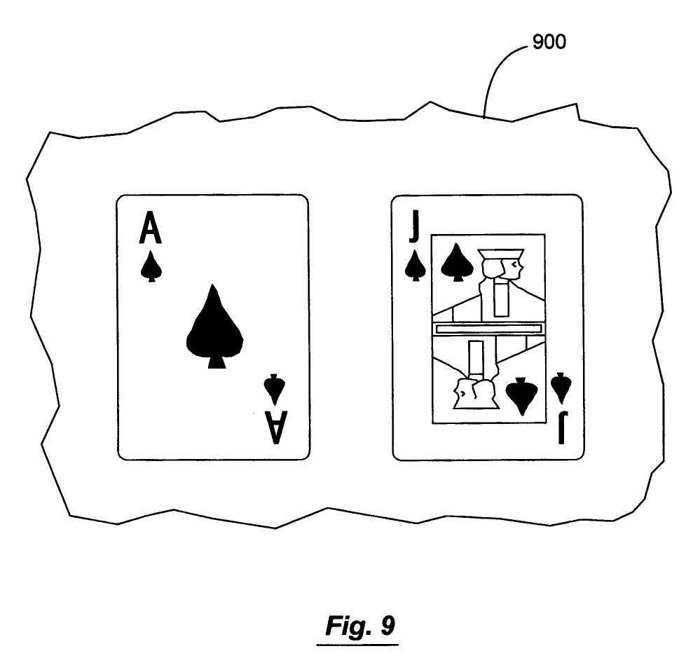

In FIGS. 8 and 9, another aspect of the method of the present invention is further shown. This is the detection of a predetermined sequence or identity combination of cards occurring in the play of a live card table game for a bonus or progressive payoff. In FIG. 8 and in step 610 from FIG. 6, the play position memory 190 is updated to always include any new cards (or if cards have been discarded the fact that they have been discarded). Assume a bonus or progressive card sequence is added to the live card game of blackjack. As shown in FIG. 9, if the player's first two cards dealt are first an Ace of Spades and second a Jack of Spades, this sequence and combination is stored in memory 190 for that position. The predetermined identity combination illustrated in FIG. 9 is an identity attribute combination of suit of Spades and value of Jack and Ace. The predetermined sequence of cards being dealt (i.e., cards being read by the RF system of the present invention) at the player position is Ace/Spades and then Jack/Spades. In FIG. 8, the local control 140 continually monitors the cards as they are dealt, sensed, and then stored in the memory for the play position 190. Based upon the bonus game rules 800 stored in memory, the local control 140 when detecting a bonus winning condition such as a predetermined sequence and/or identity combination of cards are dealt to a player position, such as the Ace and Jack of Spades in the sequence dealt as shown in FIG. 9 will issue a bonus signal 810 based upon the bonus game rules. By way of another example, it is possible for a player, while playing blackjack, to receive two Aces and to split the two Aces and then to receive two more Aces for a total of four Aces. The local control 140 could detect the presence of the four Aces and based upon the bonus game rules 800 award that player a bonus or progressive payoff. This feature is vigorous in that it is adaptable to any bonus game or live card games based upon combinations, sequences, etc. For example, in the live card game of Poker if a player is dealt a Royal Flush in the precise order of 10, Jack, Queen, King, and Ace of the same suit this precise dealing sequence as well as the precise combination could be detected by the local control 140 and a bonus payoff or progressive payoff made.

A variation of the present invention uses a bonus attribute in one (or more) of the cards. When read by the RF system of the present invention, a bonus condition or state is entered. The bonus condition could be a surprise pay off, etc. The bonus state could be bonus game play, such as spinning a wheel, etc. In this variation, the bonus attribute is unknown to the player and suddenly causes a bonus condition when read. One or more cards in a deck can have their own bonus attribute. In a further variation, the bonus attribute can be randomly selected by the system of the present invention before each game or with each shuffle, etc. In a further variation, the bonus attribute can carry a bonus payoff value. In a further variation, the card identification number (or other attributes stored such as value and suit) can serve as the bonus attribute and be randomly selected before the hand to result in the bonus condition).

The above disclosure sets forth a number of aspects and embodiments of the present invention. Those skilled in this art will however appreciate that other arrangements or embodiments, not precisely set forth, could be practiced under the teachings of the present invention.

1. A method for tracking playing cards in a live casino game played on a game table, the method comprising:
reading with an radio frequency identification system, at selected times during play of the live casino game, attributes of each card at a play position on the game table from a radio frequency identification tag affixed to the aforesaid each card,
storing the attributes for each new card read at each play position in a memory of the radio frequency system in response to reading at each selected time so that the memory contains the attributes of all cards at the play position during play of the live casino game.

2. The method of claim 1 wherein reading comprises:
transmitting a radio frequency power signal and data to the radio frequency identification tag in each card from an antenna located on the game table at each said play position,
receiving a radio frequency data signal from the radio frequency identification tag with an antenna located on the game table at each said player position in response to transmitting.

3. The method of claim 1 wherein reading at said selected times is periodic.

4. The method of claim 1 wherein reading at the selected times is other than periodic.

5. The method of claim 1 wherein the attributes at least include rank and suit data for each card.

6. The method of claim 5 wherein the attributes further includes deck identification data for each card.

7. The method of claim 5 wherein the attributes further includes casino identification data for each card.

8. The method of claim 5 wherein the attributes further include a bonus attribute.

9. The method of claim 1 wherein storing comprises:
marking the stored attributes of a card as discarded in memory when a card read and stored is not present at the play position during a subsequent selected time of reading.

10. The method of claim 8 further comprising:
reading with the radio frequency system, at the selected times, during play of the live casino game attributes of each discarded card in a discard rack from the radio frequency identification tag in the aforesaid each card,
verifying that the attributes for each card in the discard rack corresponds to the attributes of a card in memory at a play position marked as discarded.

11. The method of claim 10 further comprising:
issuing an alarm signal when verification fails.

12. A method for tracking playing cards in a live casino game played on a game table, the method comprising:
reading, with a radio frequency system located on the game table, at selected times during play of the live casino game, attributes of each card at a play position on the game table from a radio frequency identification tag affixed to the aforesaid each card,
issuing a bonus signal when a bonus condition exists in the attributes of the cards read at a play position.

13. The method of claim 12 wherein the bonus condition is at least based a predetermined identity combination of cards read at the play position.

14. The method of claim 12 wherein the bonus condition is at least based on a predetermined sequence of cards read at the play position.

15. The method of claim 12 wherein the bonus condition is based on a predetermined identity combination of cards read at the play position read in a predetermined sequence at the play position.

16. The method of claim 12 wherein a bonus condition exists in a separate bonus attribute.

17. A method for monitoring game play in a live casino game played on a game table, the method comprising:
reading with a radio frequency system, at selected times during pay of the live casino game, attributes of each card and each wager placed at a play position on the game table from a radio frequency identification tag affixed to the aforesaid each card and each wager,
storing the attributes for each new card and each new wager read at the play position in a memory of the radio frequency system in response to reading at each selected time so that the memory contains the attributes of all cards and all wagers at the play position during play of the live casino game,
when an additional wager has been made at the player position, reading the attributes of the additional wager,
reading, at the aforesaid player position in response to reading the additional wager, the attributes of any subsequent card or cards dealt to the player position in response to the additional wager,
storing the attributes for the additional wager ad for the new cards or cards dealt to the one player position.

18. The method of claim 17 further comprising:
issuing an alarm when the attributes for the read additional wager is not permitted based upon rules of the live casino card game.

19. The method of claim 17 further comprising issuing an alarm when the read subsequent cards are not permitted based upon the ruler of the live casino card game.

20. A system for monitoring game play in a live card game played on a game table, using a plurality of playing cards, the game table having a plurality of play positions, the system comprising:
a radio frequency identification tag in each playing card of said plurality of playing cards, said tag containing attribute data at least identifying the value and suit of the aforesaid playing card,
a radio frequency system at said game table for reading, at selected times, the attribute data in playing cards at each of said plurality of play positions having cards during play of the live card casino card game,
a memory in said radio frequency system for storing the read attribute data for each play position.
